(19) United States
(12) Patent Application Publication
(10) Pub. No.: US 2024/0179049 A1
(43) Pub. Date: May 30, 2024

(54) SYSTEMS AND METHODS FOR DEVICE MANAGEMENT IN A NETWORK

(71) Applicant: BCE Inc., Verdun (CA)

(72) Inventors: Bruce SHEPPARD, Ottawa (CA); Paul SHERRATT, Ottawa (CA); Cedric CRUPI, Ottawa (CA); Kevin KRATZ, Victoria (CA)

(21) Appl. No.: 18/518,668

(22) Filed: Nov. 24, 2023

Related U.S. Application Data
(60) Provisional application No. 63/427,947, filed on Nov. 25, 2022.

(51) Int. Cl. H04L 41/0803; H04L 9/40; H04L 41/0853; H04L 41/0859; H04L 41/0869

(52) U.S. Cl. CPC H04L 41/0803; H04L 41/0856; H04L 41/0863; H04L 41/0869; H04L 63/18

(57) ABSTRACT

The present disclosure describes systems and methods for managing devices in a network, including implementing a change to a device on a network, and repairing a device on a network.

### CROSS-REFERENCE TO RELATED APPLICATIONS

This application claims benefit of U.S. Provisional Application 63/427,947 filed Nov. 25, 2022, which is incorporated herein by reference in its entirety.

### TECHNICAL FIELD

The present disclosure relates to managing devices in a network, and in particular to responding to device failures.

### BACKGROUND

Network equipment, including devices such as load balancers, firewalls, switches, and any other equipment that permits SSH, occasionally fail. In some instances, a monitoring tool may discover an incident. In other instances, the network equipment may fail after attempting to implement a change. In either case, the network equipment may be rendered inoperable and/or there may be a loss of connectivity between the device and a central server. As one example, a device's routing table may be changed, and other devices that have not been updated cannot communicate with the device, therefore losing connection access to the device.

When a device fails, there is no notification from the device or from a server attempting to implement a change. Instead, device failures are typically detected by a monitoring system. Responding to the failure requires human intervention. An operator is required to detect and then login to the failed device to troubleshoot and address the cause of the failure, requiring hours to days of human resource effort and time taken before the device is recovered. In the meantime, end-users are negatively affected by the failed equipment. Further, the company managing the network equipment may face penalties under service level agreements due to the failed equipment and the time taken to restore the equipment.

Accordingly, systems and methods for managing devices in a network remains highly desirable.

### BRIEF DESCRIPTION OF THE DRAWINGS

Features and advantages of the present disclosure will become apparent from the following detailed description, taken in combination with the appended drawings, in which:

FIG. 1 shows a representation of a system for managing devices in a network;

FIG. 2 shows a method of implementing a change to a device on a network;

FIGS. 3A and 3B show a further method of implementing a change to a device on a network;

FIG. 4 shows a representation of implementing a change procedure;

FIG. 5 shows a representation of identifying a failure;

FIG. 6 shows a representation of reverting changes using ilom;

FIG. 7 shows a representation of the remediation architecture used to repair a device error;

FIG. 8 shows a method of repairing a device on a network;

FIG. 9 shows a flow chart of events that trigger the repair script;

FIGS. 10A and 10B show methods of implementing a repair procedure when a device is down;

FIG. 11 shows a method of implementing a repair procedure for other types of device errors; and

FIG. 12 shows a representation of the architecture implementing the repair script.

It will be noted that throughout the appended drawings, like features are identified by like reference numerals.

### DETAILED DESCRIPTION

In accordance with one aspect of the present disclosure, a method of implementing a change to a device on a network is disclosed, comprising: receiving a change procedure defining the change to be applied to the device; performing a pre-configuration backup to store a first configuration of the device prior to applying the change; implementing the change procedure to apply the change to the device; and performing validation testing to confirm whether the change to the device is successful, wherein if the validation testing indicates that the change to the device is unsuccessful, reverting the device to the first configuration.

In some aspects, reverting the device to the first configuration comprises: determining if the device is reachable over the network; if the device is not reachable over the network, connecting to the device via an out-of-band management connection; and applying a revert change procedure to revert the device to the first configuration.

In some aspects, the method further comprises: performing the validation testing to confirm whether the revert change procedure is successful, wherein: if the revert change procedure is successful, the method further comprises notifying that the change to the device was unsuccessful, and if the revert change procedure is unsuccessful, the method further comprises triggering a repair script.

In some aspects, when the repair script is triggered, the method further comprises: receiving an indication of a hostname and error type; determining a device type from the hostname; determining a repair procedure based on the device type and the error type to resolve the error type and return the device to the first configuration; and applying the repair procedure to the device in attempt to resolve the error type.

In some aspects, determining the repair procedure comprises predicting a best repair procedure using a machine learning model.

In some aspects, determining the repair procedure comprises determining one or more known fixes for the device type and the error type.

In some aspects, the error type is any one of: device is down, VPN is down, and memory/processing is too high.

In some aspects, the method further comprises: determining if the error type has been resolved, wherein: if the error type has been resolved, the method further comprises storing the repair procedure in association with the device type and error type in the database of known fixes, and sending a notification that the error type has been resolved, and if the error type has not been resolved, sending a notification that the error type has not been resolved.

In some aspects, the method further comprises, when the error type has not been resolved, determining if the device is critical, and sending a first notification if the device is critical, and sending a second notification if the device is not critical.

In some aspects, the method further comprises: confirming, before implementing the change procedure, that the device is reachable over the network; and when the device is not reachable, indicating a change failure.

In some aspects, if the validation testing indicates that the change to the device is successful, the method further comprises performing a post-configuration backup to store a second configuration of the device after applying the change.

In accordance with another aspect of the present disclosure, a method of repairing a device on a network is disclosed, comprising: receiving an indication of a hostname and error type; determining a device type from the hostname; determining a repair procedure based on the device type and the error type to resolve the error type and return the device to the configuration prior to applying the change; and applying the repair procedure to the device in attempt to resolve the error type.

In some aspects, determining the repair procedure comprises predicting a best repair procedure using a machine learning model.

In some aspects, determining the repair procedure comprises determining one or more known fixes for the device type and the error type.

In some aspects, the error type is any one of: device is down, VPN is down, and memory/processing is too high.

In some aspects, the method further comprises: determining if the error type has been resolved, wherein: if the error type has been resolved, the method further comprises storing the repair procedure in association with the device type and error type in the database of known fixes, and sending a notification that the error type has been resolved, and if the error type has not been resolved, sending a notification that the error type has not been resolved.

In some aspects, the method further comprises, when the error type has not been resolved, determining if the device is critical, and sending a first notification if the device is critical, and sending a second notification if the device is not critical.

In some aspects, receiving the indication of the device type and the error type is received from a monitoring system that monitors the device, or from a change system that attempted to apply a change to the device.

In accordance with another aspect of the present disclosure, a system is disclosed, comprising: a processor; and a non-transitory computer-readable memory storing computer-executable instructions thereon, which when executed by a processor, configure the system to perform the method of any one of the above aspects.

In accordance with another aspect of the present disclosure, a non-transitory computer-readable memory is disclosed storing computer-executable instructions thereon, which when executed by a processor, configure the processor to perform the method of any one of the above aspects.

The present disclosure describes systems and methods for managing devices in a network, including implementing a change to a device on a network, and repairing a device on a network. In accordance with the present disclosure, failures can be automatically detected after attempting to implement a change, and attempts can be made to revert changes in the event of device failure. Further, if a device has failed and the change cannot readily be reverted, a repair script can be triggered for resolving the device error. The repair script can utilize various information in attempt to automatically determine and troubleshoot the device error. Machine learning can also be employed to predict best procedures for repairing a device error. The repair script may be triggered not only after a device change failure, but can also be triggered if a device failure is identified during regular network equipment monitoring.

Advantageously, the automated processes disclosed herein can identify device failures and attempt to revert changes and repair errors in the devices without human intervention. Accordingly, device recovery time can be shortened from days/hours to minutes, and resource effort of human operators can be fully automated. The network devices can be accessed using both in-band and out-of-band device management, thus allowing remote connection with the devices, even if the device is not reachable using secure shell (SSH) or https.

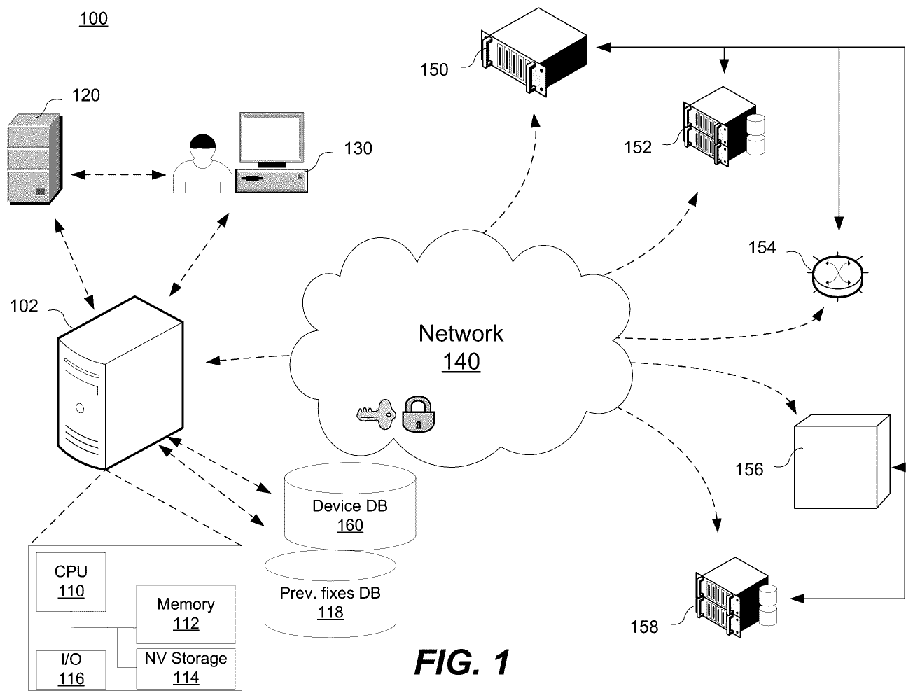

Embodiments are described below, by way of example only, with reference to FIGS. 1-12.

FIG. 1 shows a representation of a system 100 for managing devices in a network. The system 100 comprises a central server 102 that is configured to communicate with various network devices (such as servers 152 and 158, router 154, and firewall 156) over a network 140. The central server 102 may as an example be a hardened Red Hat Python server. The network devices may belong to the same company that operates the central server 102, or they may belong to a third party and be managed by the central server 102. Further, the devices may belong to different units within an organization, and be managed by the central server 102. While only four devices are shown in FIG. 1, it will be appreciated that the central server 102 is capable of managing many more devices, including other types of devices, and devices provided by different vendors. The device can generally be from any vendor that supports SSH commands or management API calls.

In addition to being communicatively coupled to the network devices over the network 140, the central server 102 is also configured to be communicatively coupled to the network devices via an out-of-band management interface shown by connection with a console server 150 that is hard-wired to ilom (integrated lights out management) ports of the devices (servers 152 and 158, router 154, and firewall 156). As described in more detail herein, this system configuration of using both in-band and out-of-band management advantageously allows for connection to failed devices even when they are not reachable over the network 140.

The central server 102 is shown comprising computer elements including CPU 110, non-transitory computer-readable memory 112, non-volatile storage 114, and an input/output interface 116. The non-transitory computer-readable memory 112 is configured to store computer-executable instructions that are executable by the CPU 110 and cause the central server 102 to perform certain functionality, including a method of implementing a change to a device, and a method of repairing a device on a network. The instructions may be written as a Python script that is executable by the CPU 110. The central server 102 may also access one or more databases, such as a database of previous fixes 118, which may comprise information on previous error types for devices on the network and their associated fixes, as well as device database 160, which may comprise information for the devices on the network, as described in more detail herein.

The central server 102 is also configured to communicate with an automation server 120, which may for example be an Ansible Tower. The automation server 120 may be used by an operator 130 to define a change procedure for a device on the network and to send the change procedure to the central server 102. The automation server 120 and the central server 102 may be connected via SSH. The central server 102 may also communicate directly with the operator 130 (and/or other operational personnel or support technicians, not shown), such as to output notifications, as described further herein.

The system 100 can use encrypted-in-transit and encryption-in-rest procedures to ensure security and support Protected B deployments. As represented in FIG. 1, all communication over the network 140 may be encrypted. Further, data stored at the central server 102 and/or in databases 118 and 160 may also be encrypted. As an example, the script stored at the central server 102 for executing a method of implementing a change to a device and a method of repairing a device on the network may be encrypted with AES 256 and an executable binary. The key that generates this encrypted executable binary can be discarded so that no team member has access to it. The script file therefore cannot be human read, nor reverted from a binary to original source code.

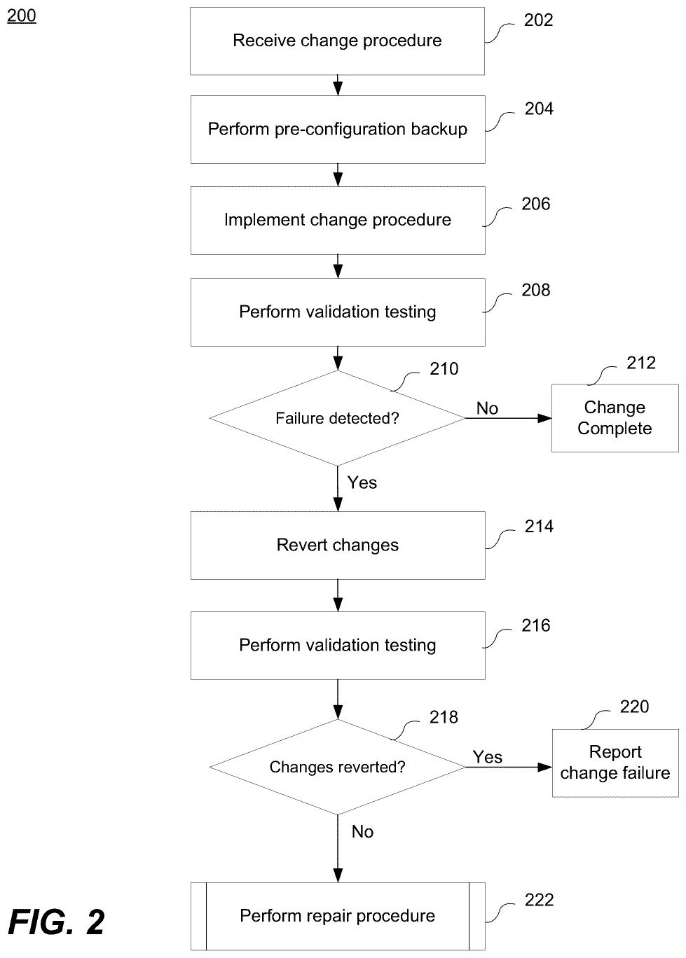

FIG. 2 shows a method 200 of implementing a change to a device on a network. The method 200 may for example be performed by the central server 102 as shown in FIG. 1, when executing the script stored in memory.

A change procedure is received (202), which defines the change to be applied to the device. The change procedure may be received at the central server 102 from the automation engine 120. The operator 130 may create a change procedure (also known as a Method of Procedure (MOP)) in the automation engine 120. In accordance with the present disclosure, the change procedure should generally comprise six variables:
(1) A Change request number (CRQ);
(2) The device or devices requiring the Change;
(3) Change Commands (i.e. the commands required for the change to be successful and defined in the approved CRQ);
(4) Revert Commands (i.e. the commands required for the change to revert should a detected failure occur);
(5) Test IP Addresses (e.g. could be any host that should be reachable before and after the change); and
(6) The test type (i.e. the type of test that confirms failure of success of the change via any protocol).

After creating the change procedure, the operator 130 may schedule the change at a particular date and/or time. At the specified date/time, the automation engine 120 sends the change procedure to the central server 102.

The central server 102 performs a pre-configuration backup (204) on the device requiring the change, and stores the device configuration. The pre-configuration backup stores the entire configuration of the device requiring the change.

The change procedure is implemented (206), by connecting to the device via SSH or https and providing the change commands required to complete the change. It is expected that the device requiring the change is reachable. If the device is not reachable the change is classified as a failure and a critical alert sent. Prior to applying the change commands, the central server 102 may also track and test connectivity to the test IP address specified in the change procedure.

Validation testing is performed on the device (208) in accordance with the test type and test IP addresses specified in the change procedure to confirm that the change to the device is successful. There are two possible outcomes from the validation testing:
(1) The device and corresponding back-end test is still reachable. The successful tests indicates a successfully changed device and the system state passed.
(2) The internal or external connectivity tests fail. In this scenario, the device is unable to complete the tests as expected.

A determination is made as to whether a failure is detected from the validation testing (210). When there is no failure detected (NO at 210), i.e. the validation testing indicates that the change to the device is successful, the change is complete (212). In this case the method may further comprise performing a post-configuration backup to store the configuration of the device after applying the change.

When a failure is detected (YES at 210), the central server 102 attempts to revert the changes made to the device (214), by reverting the device to its pre-configuration using the revert commands listed in the change procedure.

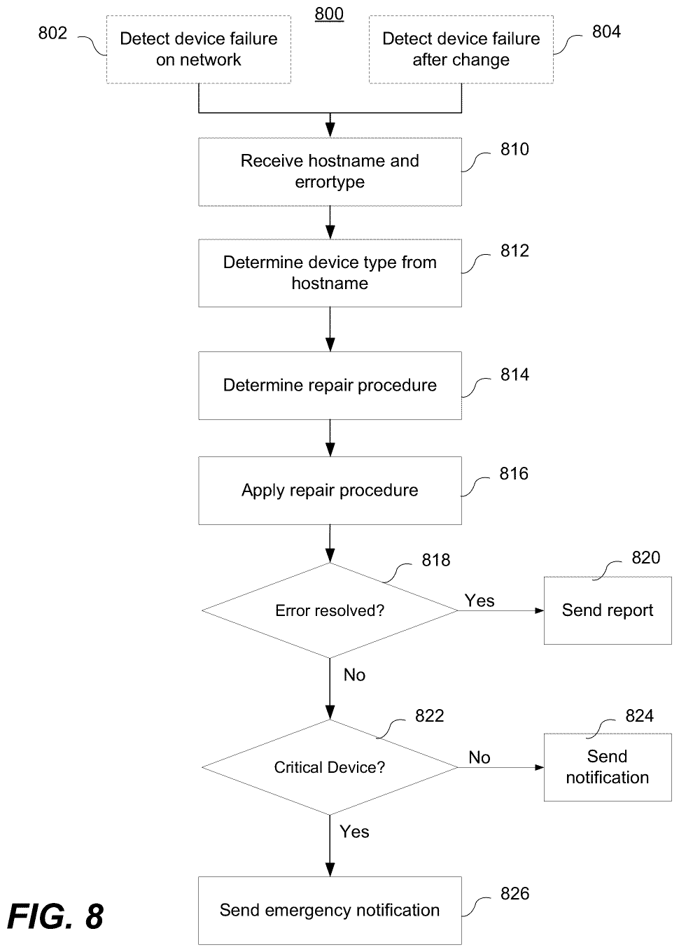

After the revert commands have been applied to the device, validation testing is again performed (216), and a determination is made as to whether the changes have been successfully reverted (218). If the changes have been reverted (YES at 218), i.e. the device passes the validation testing after the revert commands have been applied, the device is determined to be in its pre-configuration state and the change failure is reported (220). If the changes have not been reverted (NO at 218), i.e. the device fails the validation testing after the revert commands have been applied, it is determined that there is an error in the device due to the attempted change and a repair procedure is performed (222), as further described with reference to FIG. 8.

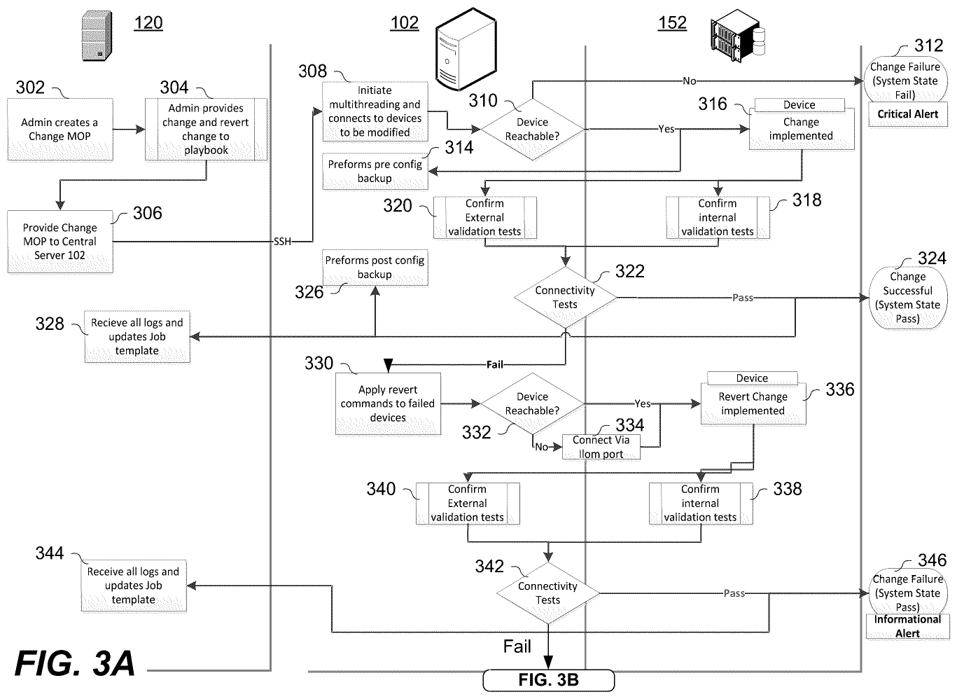

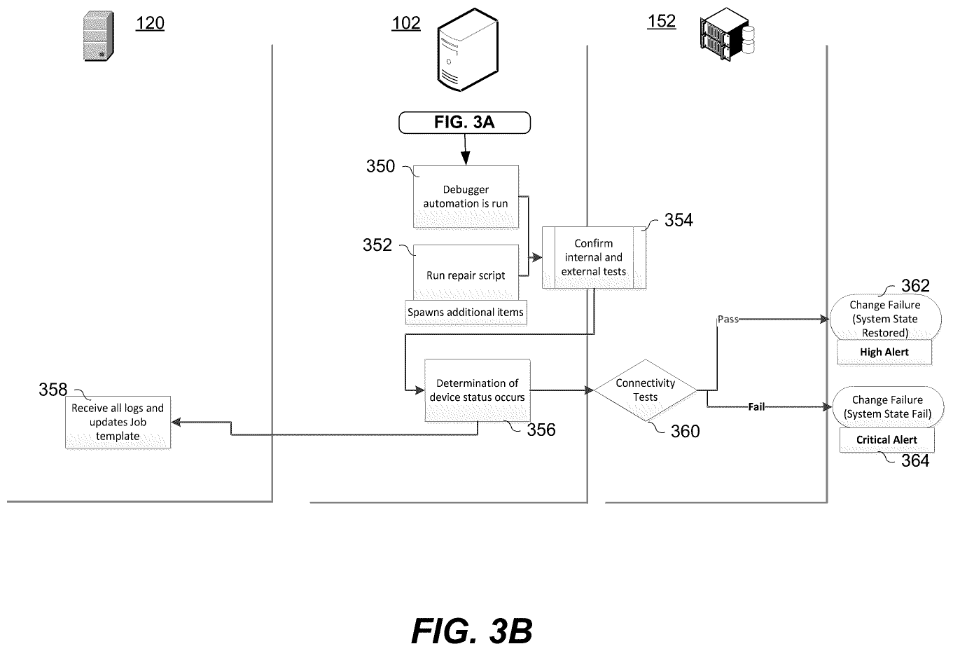

FIGS. 3A and 3B show a further method of implementing a change to a device on a network, including communication between the automation engine 120, the central server 102, and the device 152 undergoing the change.

At the automation engine 120, an administrator creates a change procedure (302), and adds variables including change and revert change procedures (304), as also been described with reference to the method 200. The automation engine 120 provides the change procedure to the central server 102 (306).

The central server 102 receives the change procedure and runs the corresponding script to implement the change. Once the script has all of the variables the central server 102 initiates multithreading and connects to the device or devices to be modified (308), in this case device 152. The central server 102 determines if the device 152 is reachable (310). It is expected that the device 152 is reachable. If the device 152 is not reachable (NO at 310), the change is classified as a failure and a critical alert is sent to the team responsible for the change/device (312). The alert depending on the device can be an email or an SMS to the responsible team.

If the device is reachable, the central server 102 will track and test connectivity to the Test IP address, and also performs a pre-config backup (314) that stores the configuration of the entire device. The central server connects over SSH or https and provides the commands required to implement the change (316).

Validation testing is performed, including both internal validation tests (318) and external validation tests (320). A determination is made as to whether the connectivity tests are passed or failed (322). There are two possible outcomes from the tests:
(1) The device and corresponding back end test is still reachable (Pass at 322). This would result in a changed device with successful tests indicating a successful change and the system state passed (324). The central server 102 preforms a post device configuration backup to update its internal database (326). Logs are sent to the automation engine 120, which updates the job template (328).
(2) The internal or external connectivity tests fail (Fail at 322). In this scenario the connectivity tests that are predicted to work do not work. From this there are a number of actions that occur.

The central server 102 attempts to apply revert commands to the failed device(s) (330), and determines if the device is still reachable and if it can continue to manage the device from SSH (332). If the device is reachable (YES at 332), the central server 102 applies the revert change commands to implement the revert change at the device (336). If the device is not reachable (NO at 332), the central server connects via the lights out ilom port (334), e.g. via an OpenGear. The OpenGear connects to the device in question via a console cable. This method of connectivity provides the highest availability level of management connectivity as its output is directly off the configured device. Once connected via the ilom port the central server will apply the commands listed in the revert commands defined in each change procedure (336). As previously described, the change procedure defines as accurate of back-out procedure as possible. The revert change commands should revert the device to the status before the changes were implemented.

After the revert commands have been run, the central server 102 again runs the internal validation tests (338) and external validation tests (340). A determination is made as to whether the connectivity tests pass or fail (342). If the connectivity tests pass (Pass at 342), all logs are provided to the automation engine (344) and the corresponding IT ticket. The central server 102 will report the change as a change failure requiring revert commands with a system state as passed (346). Depending on the device, a notification such as an email will be sent to the owner notifying the change failure.

If the connectivity tests fail (Fail at 342), it is determined that there is an error in the device and a remediation procedure begins, as described further with reference to FIG. 3B.

Referring now to FIG. 3B, the remediation procedure comprises running a debugger tool (350), which has a role of automated failure detection and detailed debug information gathering and correlation. If a failure occurs on a network, the discovery of the source of failure can typically take a long time requiring multiple manual tasks. The debugger tool works by having access to a virtual map of the entire environment/network, and is based on a source ip address, destination ip address, and port, that may be used to map the network and associated flows, layer 3 hops and tcp dumps. Once a change occurs on the network and fails the virtual map is used based on the variables provided. The debugger tool will log in to each firewall in the path and performs a traffic capture (tcp dump) to provide troubleshooting details in an IT ticket for review. This information provides the team with information confirming if the firewall port is open on the external flow. The debugger tool may also provide a picture in jpeg format of all of the networks in the path and potentially showing where a route would be missing in the path. The team may also receive in the ticket a packetcapture running to determine if a 3-way handshake was successful. Lastly, the debugger tool may also provide any and all error codes required for a quick discovery of the failure.

Further, the central server 102 runs a repair script (352), which is described in more detail with reference to FIG. 8.

After running the debugger tool (350) and the repair script (352), the central server 102 confirms internal and external tests again (354), and provides a determination of device status (356). The central server 102 updates the automation engine 120 of its findings and discovered errors (358). Connectivity tests are performed (360), which provides two possible outcomes:
(1) The connectivity tests Pass due to the changes of the repair script (Pass at 360). The central server 102 will provide the automation engine and corresponding IT ticket an update describing all of the steps related from the repair script that resolved the issue and report that the Change was a failure but system state restored (362). This will be a high alert and depending on the device will provide an email notifying of the outage and possibly an SMS message to the team responsible for the device.
(2) The connectivity tests fail even after the repair script (Fail at 360), and a Critical Alert is generated and depending on the device will send a notification as an email and/or SMS to the team that is responsible with the device that failed (364). This change will be a failed change along with a system state failure.

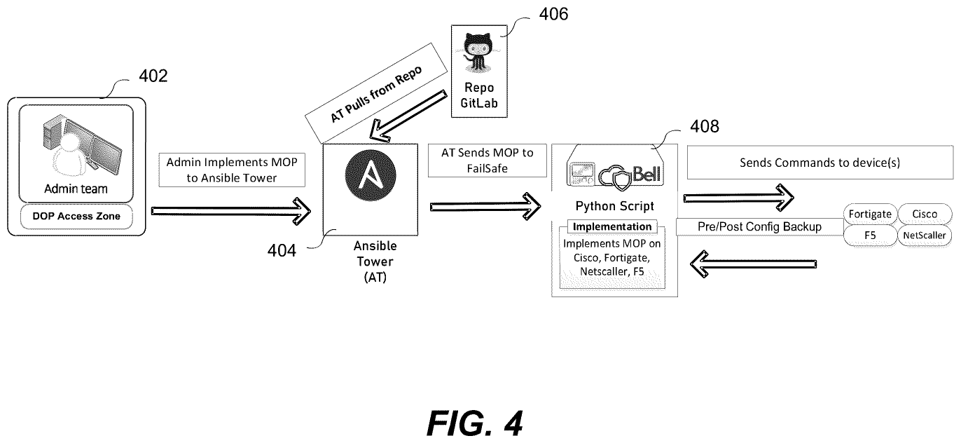

FIG. 4 shows a representation of implementing a change procedure. In FIG. 4, an administrator 402 adds the change procedure (or MOP) to the automation engine 404 (e.g. Ansible tower). The automation engine 404 pulls the latest version of the Ansible playbooks from git repository 406 for updating code, and the automation engine 404 sends the change procedure and associated variables to the central server 408 implementing a script to perform the change. The server 408 performs a full pre-configuration backup and implements the change procedure. The server 408 implements the change procedure on applications such as Cisco, Fortigate, NetScaller, F5, etc., by sending commands to the device(s). The server 408 also performs a post-configuration backup along with a notification of the change success/failure.

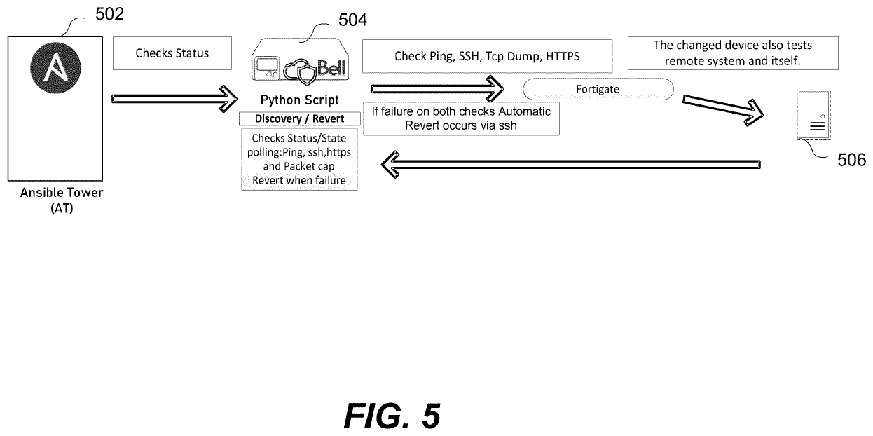

FIG. 5. shows a representation of identifying a failure, e.g. after implementing the change. The automation engine 502 records the job status and runs a status check to check the status of the changed device 506 by: (1) logging into the modified device and running a ping against the test address from the modified device; and (2) running an SSH and/or ping against the test address from the central server.

If one test fails, the initiator of the change receives completion with a warning. If both tests fail, the central server 504 will automatically revert the change. If the revert commands do not work it moves to Auto Revert via ilom. After the revert procedure, the central server 504 will check the status again, and if it fails it moves to the remediation phase.

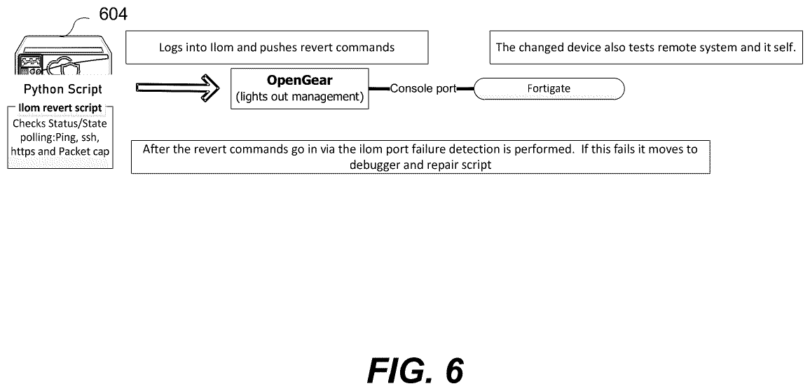

FIG. 6 shows a representation of reverting changes using ilom. The central server 604 logs into the ilom software, such as OpenGear or Raritan, and selects the correct console port. Once connected via console the central server 604 will login to the failed device and push the revert commands. After the revert commands have been entered, failure detection is performed again. If the device is still not reachable, the process moves to remediation.

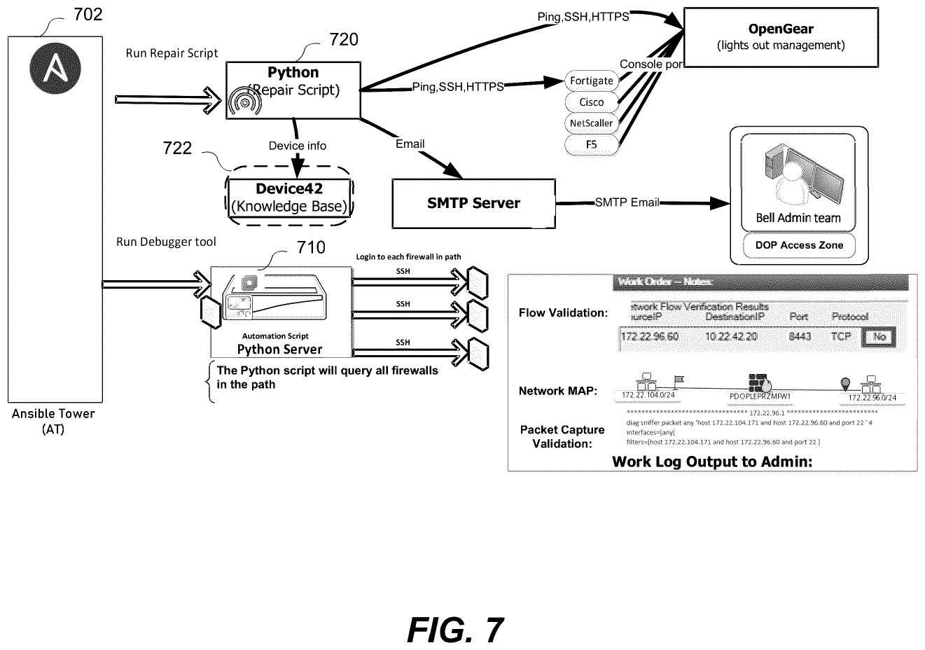

FIG. 7 shows a representation of the remediation architecture used to repair a device error. The automation engine 702 runs a debugger tool 710 and a repair script 720 at the central server against the failed device.

The debugger tool 710 is used to determine what failures occur at a network level and to update the existing ticket. The purpose of debugger tool 710 is to capture, correlate debug level information and provide all required detail back into the originating IT ticketing system ticket used to create the request, thus reducing the need to collect the detailed information manually. When the debugger tool 710 is called, variables are passed including the source IP address, the destination IP address, and the port. From those variables, the debugger tool has access to a network map of the entire network environment. This map is then used to overlay the source and destination and all associated layer 3 hops in the path. From the layer 3 devices in the path, the debugger tool script will login to each device in the path and run a packet capture based on the source, destination and port variables. The results from all of the packet captures are formatted and may be added to an original ticket number in an IT ticketing system. The network map may also be added as a jpeg to the IT ticketing system ticket showing each device in the path for the submitted variables. Based on all of the layer 3 hops it can then be determined if the firewall flow is open across all firewalls. The debugger tool 710 may perform one or more of the following: confirm if the flow is on the firewall (e.g. with Yes, No, Maybe); design a picture of the routed hops; provide a packet capture that requested traffic; analyze that traffic to confirm if the 3-way handshake was successful; and provide all error codes in the TPC/IP traffic for quick discovery of the failure. The debugger tool 710 can also provide a network map for the failed implementation. All information can be provided to an incident management tool, such as Remedy, which can call an IT ticketing system to create an action for the central server, such as to execute the repair script. From these results in the IT ticketing system all of the detail needed to troubleshoot an incident is provided, including:

If a route is incomplete or incorrect (from the network map);

If a firewall is blocking the traffic (from the TCP Dump and the automated flow check); and

Network failure types (from the TCP Dump), including: TCP 3 way handshake issues; asynchronous routing; latency; and packet loss.

The repair script 720 is used to automatically determine and correct device errors causing failure. The repair script 720 aims to repair the device to a known working state, without human intervention, and uses in-band and out-of-band management so that it can be implemented even if the device cannot be reached by SSH or https. The repair script 720 is described in more detail below.

FIG. 8 shows a method 800 of repairing a device on a network. The method 800 may be performed by the central server (e.g. central server 102 in FIG. 1), when implementing the repair script. The repair script may be triggered to run under two conditions: (1) when a device failure is detected on the network using a monitoring tool (802); and (2) when a device failure is detected after implementing a change on the device (804).

In the first condition, a monitoring tool, such as Entuity, may discover an incident and automatically create an incident ticket in an IT ticketing system for a Security Operations Center to investigate and report on. The automatic ticket generation occurs when creating “specific” error events (device down, high memory, vpn down, etc.) and based on hostname will generate an automation, for example in Atrium Orchestrator (AO). AO will take variables from the newly created incident tkt and generate an automation task to call the repair script on the central server. For example, AO can login to the central server using a service account and SSH connectivity and run a command to execute the repair script inputting the hostname and error type as variables.

In the second condition, an incident occurs due to a failed change and corresponding connectivity tests. As previously described, the script used to implement a change will attempt to revert the changes when the connectivity tests fail, however, if the revert commands do not work then the repair script is triggered for a more in-depth resolution. The change script can login to the central server using a service account and SSH connectivity and run a command to execute the repair script inputting the hostname and error type as variables.

The repair script receives a hostname and error type (810). A device type and possibly the vendor type (e.g. firewall, switch—Cisco, Fortinet) is determined from the hostname (812). From the device type and the vendor type the repair script will reach out to device database (e.g. device database 160 in FIG. 1, also shown as Device 42 in FIG. 7) via API calls to pull all of the relevant information for the device, such as:
Physical location;
Site Address;
Room Number;
Cage number;
Rack Location;
U location in rack;
Management IP address;
Admin Contact information;
Port information (for switches); and
Onsite contract.

The repair script will also review the error type from the variables received in the trigger.

Using the hostname, device type, and the error type, the repair script determines a repair procedure (814). For certain device types (e.g. Adaptive Security Appliances, or ASA), a third optional parameter, “tunPort” may be passed to the repair script. When only two parameters are passed (i.e. hostname and errortype), a default value of none may be assigned to the “tunPort” parameter. The repair procedure may be determined in part by accessing information on previous fixes (e.g. stored in previous fixes database 118 in FIG. 1) and determining previous fixes that have addressed the error type for the device. Additionally or alternatively, a machine learning model may be used to predict a best repair procedure for the device type and error type. The machine learning model may be trained so that it can predict the best fix based on the failed device information. In some implementations, the machine learning model may be trained so that it can predict the best fix based on previously applied fixes as contained in the previous fixes database. Through training the algorithm using known data, the machine learning model is used to find patterns and relationships between the input parameters and the known fixes. From insights learned in the training phase, the model will be able to predict a fix for a new hostname based off devices with similar features such as DeviceType and ErrorType, and for a known hostname, the model can use known historical fixes.

As one example, the repair script may utilize the python machine-learning library “scikit-learn” and use one or more machine learning algorithms/classifiers to predict a best fix to repair the device. As a non-limiting example, based on testing, the Multi-layer Perceptron (MLP) classifier was determined to be appropriate for predicting a best fix for a device, however it will also be appreciated that other types of algorithms and classifiers could be used.

The repair procedure is applied to the failed device (816). The repair procedure may comprise attempting to apply multiple fixes to the device (e.g. the best predicted fix, the best known fix, a next best known fix, etc.). Specific examples of repair procedures for different types of error types are described in more detail below.

A determination is made if the error is resolved after applying the repair procedure (818). If the error is resolved (Yes at 818), a report is sent (820) to the team responsible for the device detailing the issue and known resolution, and the previous fixes database is updated accordingly. Further, the training data used to train the machine learning model may be updated after each successful fix to include the given parameters and applied successful fix, which will help the model continuously learn from the new failures and in doing so, increase its ability to predict future fixes accurately and efficiently.

If the error is not resolved by the repair procedure (No at 818), a determination is made as to whether the failed device is a critical device (822). If the device is not a critical device (No at 822), a first type of notification is sent (824) to the team responsible for the device, such as an e-mail. If the device is a critical device (Yes at 822), an emergency notification such as a text or phone call is sent (826) to the team responsible for the device.

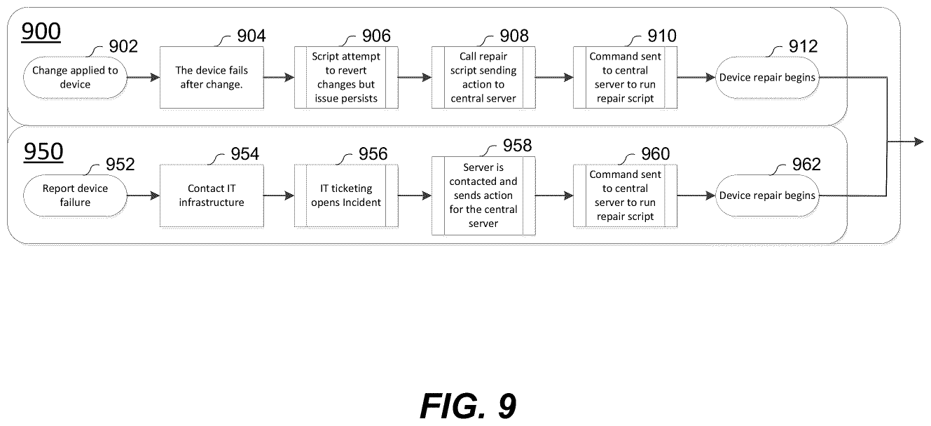

FIG. 9 shows a flow chart of events that trigger the repair script. The flow 900 represents the case when the repair script is triggered after a change failure. The flow 950 represents the case when the repair script is triggered by a monitoring tool.

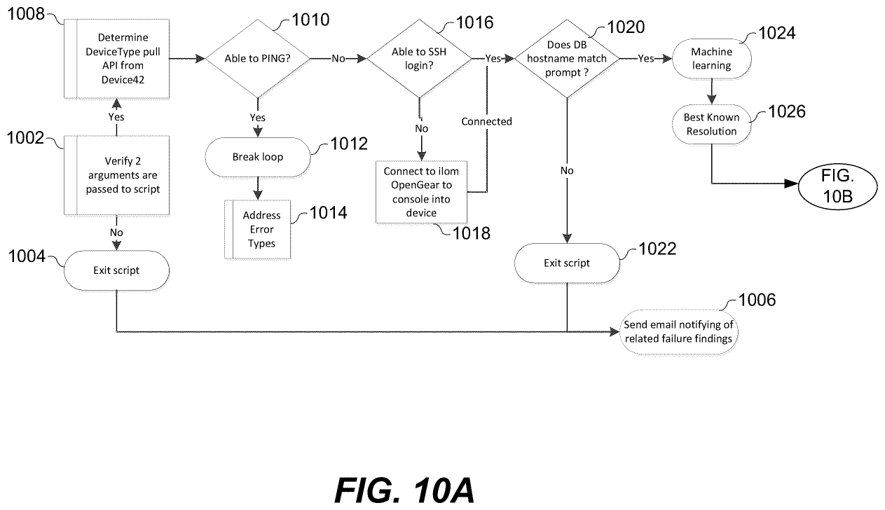

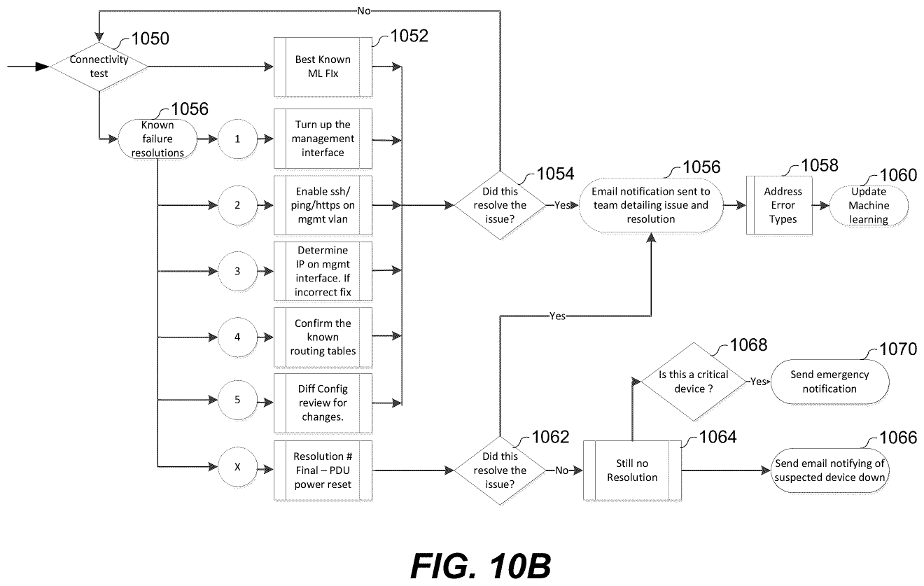

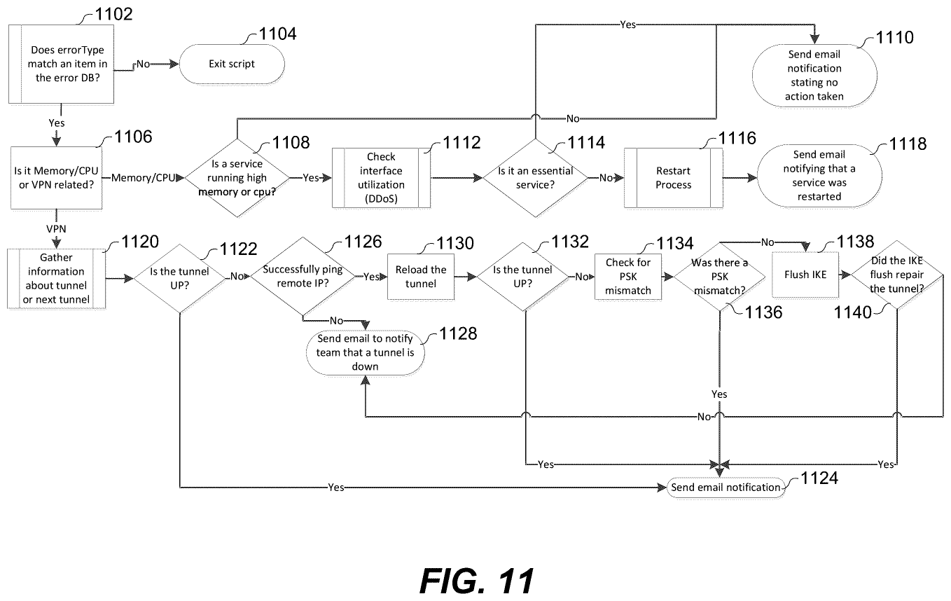

In the flow 900, a change is applied to the device (902), and the device fails after implementing the change (904). As previously described, a script attempts to revert the changes, but in this scenario the issue persists (906). The change script calls the repair script (908), and a command is sent to the central server to run the repair script (910). The repair script begins to repair the device (912), as further described in FIGS. 10 and 11.

In the flow 950, a monitoring tool reports the device failure (952). An IT solution is contacted to open an incident (954), and the incident is opened (956). The automation server is contacted and sends action for the central server (958). The command is sent to the central server to run the repair script (960). The repair script begins to repair the device (962), as further described in FIGS. 10 and 11.

FIGS. 10A and 10B show methods of implementing a repair procedure when a device is down. The method comprises verifying that the two arguments (hostname and errortype) are passed to the script. If the script has not received the two arguments (No at 1002), the script exits (1004) and an e-mail is sent to the team responsible for the device notifying of all relevant information related to the failure (1006).

If the script has received the two arguments (Yes at 1002), a determination of the DeviceType is made from the device database (1008). The server executing the script attempts to ping the failed device, and a determination is made if it can successfully ping the device (1010). If the server is able to ping the device (Yes at 1010), the script breaks the loop (1012) and addresses the error types (1014).

If the server cannot ping the device (No at 1010), a determination is made if the server can login via SSH (1016). If SSH login is unsuccessful (No at 1016), the server connects to the device via the lights out management connection (ilom), for example using OpenGear (1018). From SSH (Yes at 1016) or after connecting via ilom, the script will determine if the hostname matches the internal database record (1020). Verifying that the hostname matches the internal database record ensures that the server is not connecting to a device that it should not be connecting to. If the hostname does not match the internal database record (No at 1020), the script is exited (1022) and an e-mail sent to the relevant team (1006).

If the hostname does match the internal database record (Yes at 1020), the script determines a repair procedure for the device type and error type. To determine the repair procedure, the failing device information (hostname, device type, error type, port) can be passed into a machine learning model (1024) which, based of the data used to train the model will predict the proper fix. The machine learning model may use previous fix information to determine previous fixes applied to the same or similar device types and error types. If the machine learning has a match for hostname and successful failure resolution it may call that last resolution first. This ensures that the timeline for recovery is as fast as possible. A best known resolution is determined using the machine learning (1026).

Referring to FIG. 10B, to apply the repair procedure, a connectivity test is performed (1050). The connectivity test performed at this stage is a check to see if the device has recovered, which may not have previously been detected due to a recovery delay. For example, in some instances if a device is fixed it can take a few seconds for an arp to register on a switch or a route to aggregate. When the connectivity test indicates that the device remains down, the repair procedure applies one or more fixes to the device. The best predicted fix from the machine learning model is applied (1052), and a determination is made as to whether applying this fix resolved the issue by running a ping and attempting an SSH connection (1054). If the fix did not resolve the issue (No at 1054), the method returns to performing the connectivity test (1050).

Known failure resolutions are applied (1056), which can be applied incrementally, determining after each attempted fix whether it resolved the issue (1054). Six example known fixes for a device down are shown in FIG. 10B, however it will appreciated that the known resolutions will constantly expand as issues are discovered by technicians and can quickly add to this list. The first six options listed below are samples of known resolutions:
(1) To confirm the management interface—from ip address and port relating to information on the device database. The script will ensure the management interface is up. This can be completed for the different vendors.
(2) Enable management ports on the device management interface-from ping, https and SSH. It will then track the pre and post for the management ports and their status, then add that to the logs.
(3) From the IP tracked above, preform a Diff on the management IP address and the address listed in device database for the specified port. If the IP address is different than expected it will then change the IP address to what is expected on the device.
(4) Confirm the routing table for the management interface and routes only. If the routing table is not as expected it will then add the pre-configured routes for the failed host.
(5) Confirm the last known good configuration and look at the Diff output of the two configurations. If the configuration is different it will then apply the last known good configuration and confirm connectivity tests.
(6) Use intelligent Power Distribution Units (PDUs) connected to the servers. From the internal database the server can turn off the specific A power connection along with B power connection using authenticated API calls to the PDU. Then the PDU can be rebooted. This option is the last resort for failure resolutions, and may only be applied for some hosts.

Note that the above examples of fixes are non-limiting, and also that the attempted fixes, including fixes predicted by the ML model and known fixes, can be performed in different orders without departing from the scope of this disclosure.

If any of the attempted fixes resolved the issue (YES at 1054), a notification (e.g. an e-mail) is sent (1056) to the team detailing the issue and known resolution. The notification to the team can also include all information related to the device and error types received, including the device location, building location, Room number, cage number, rack number and rack U number. The notification may also include the on site contact number and support desk to open a tkt. The method also comprises updating the Machine Learning datasets and the previous fixes database with information on the successful fix (1058, 1060).

If none of the attempted fixes resolved the issue (No at 1062), it is determined that there is still no resolution (1064), and a notification such as an e-mail is sent notifying of the suspected device down (1066). Further, a determination is made as to whether the device is critical (1068), and if the device is critical (Yes at 1068), an emergency notification is sent (1070), such as an SMS.

FIG. 11 shows a method of implementing a repair procedure for other types of device errors. It will be appreciated that the repair script can be used for repairing various types of device error types, and that the list of previous fixes for different device types and error types can be continuously expanded. For the sake of example, FIG. 11 shows a method for repairing a device error type caused by high memory and for repairing a device error type caused by a down VPN. Other examples of error types could be intDown (interface is down), asaDown (ASA device is down) and many more. The machine learning model may be used to optimize the repair procedure and predict the best fix.

A determination is made as to whether the received error type matches an error type in the previous fixes database (1102), and if not (No at 1102), the script exits (1104). If the received error type matches an error type in the known fixes database (Yes at 1102), the type of error type is determined (e.g. in this case, high memory or VPN) (1106).

If the received error type is that the memory of a device is too high, this can be CPU or Memory related (Memory/CPU at 1106). It is assumed that device scaling is not an issue and this issue could be related to a bug, memory leak or denial of service. The first check it preforms is to login to the failed device via SSH, or via the ilom port. Also the hostname in the prompt must match the error code call or the script will be exited. The method may comprise running a number of commands depending upon the vendor and determine if there is actually a high memory and or CPU issue (1108). If there is no high memory or CPU issue (No at 1108) the method will send a notification and end the task. If the system does have a high memory or CPU (Yes at 1108), the method will confirm other factors like interface utilization (1112) to check for a possible DDOS attack. The commands used to determine high memory and CPU will also provide the list of services using the resources. A determination is made as to whether the service running/consuming the most Memory and CPU is an essential service (1114), and if not (No at 1114), the process is restarted. An notification of the actions taken and post results for the system in question is sent (1118).

If the received error type is that the VPN connection is down (VPN at 1106), the method verifies that the tunnel in question is down by gathering information about the tunnel (1120) and determining whether the tunnel is up (1122). If the tunnel is up (Yes at 1122), an email notification to the responsible team is sent (1124). If the tunnel is down (No at 1122) the method will attempt to ping the remote IP (1126). If the ping is unsuccessful (No at 1126), the team is notified that the tunnel is down (1128). If the ping is successful (Yes at 1126), the method attempts to reload the tunnel (1130), and a determination is made if the tunnel is up (1132). If the tunnel is up (Yes at 1132), the team responsible is notified (1124). If the tunnel is still not up (No at 1132), the method checks the PSK for a mismatch (1134). If it is determined that there is a mismatch (Yes at 1136) the responsible team is notified (1124). If not there is not a mismatch (No at 1136) the method will flush the IKE table (1138) and attempt to reload the tunnel. A determination is made as to whether the IKE flush repaired the tunnel (1140). If the IKE flush repaired the tunnel (Yes at 1140), the responsible team is notified (1124). IF the IKE flush did not repair the tunnel (No at 1140), the method will notify the team of its findings and also alert the team (1128).

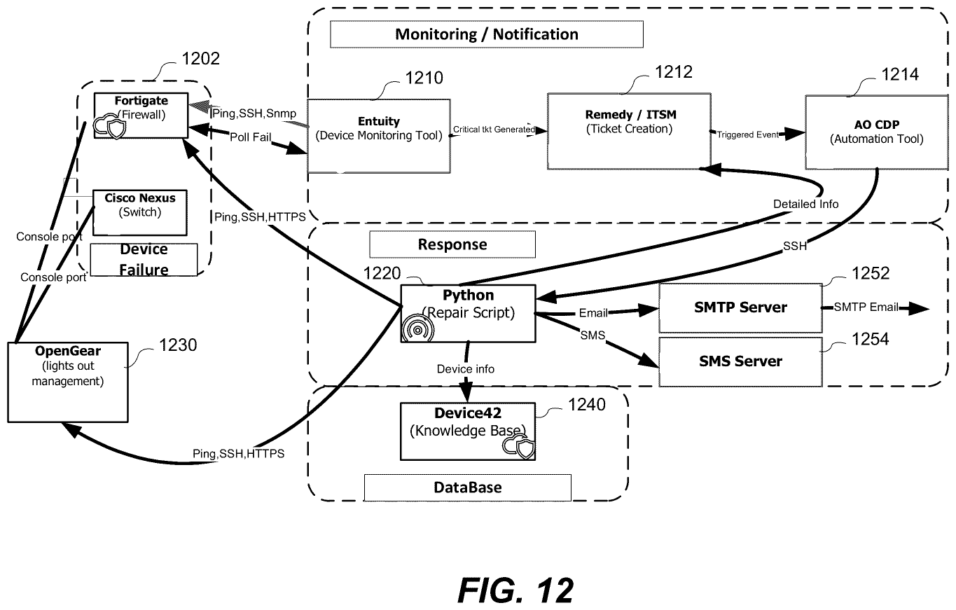

FIG. 12 shows a representation of the architecture implementing the repair script. In this exemplary architecture, a monitoring tool 1210 polls device 1202, and when a failure is detected, creates a ticket in an IT Ticketing solution 1212. Once an incident tkt has been generated for the device 1202, the IT solution 1212 calls the automation tool 1214, which creates an action to the central server for implementing the repair script 1220 and provides the hostname and errortype variables.

The repair script 1220 will attempt to login to the device 1202 the ticket was created for to run commands to fix it. As previously described, when the repair script cannot reach the device via ping, SSH, or HTTPS, it may connect via lights out management (i.e. with OpenGear 1230).

The repair script 1220 runs diagnostics and restarts services depending if the script is run as intrusive or not. The repair script 1220 may access the knowledge base 1240 to determine device information for determining the best repair fix.

After all diagnostics have been run and an attempted fix applied, the repair script may cause an e-mail from SMTP Server 1252 and/or an SMS from SMS Server 1254 to the responsible team reporting on device status and all information needed, including information to find the device or port in question.

It would be appreciated by one of ordinary skill in the art that the system and components shown in the figures may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

1. A method of implementing a change to a device on a network, comprising:
receiving a change procedure defining the change to be applied to the device;
performing a pre-configuration backup to store a first configuration of the device prior to applying the change;
implementing the change procedure to apply the change to the device; and
performing validation testing to confirm whether the change to the device is successful,
wherein if the validation testing indicates that the change to the device is unsuccessful, reverting the device to the first configuration.

2. The method of claim 1, wherein reverting the device to the first configuration comprises:
determining if the device is reachable over the network;
if the device is not reachable over the network, connecting to the device via an out-of-band management connection; and
applying a revert change procedure to revert the device to the first configuration.

3. The method of claim 2, further comprising:
performing the validation testing to confirm whether the revert change procedure is successful,
wherein:
if the revert change procedure is successful, the method further comprises notifying that the change to the device was unsuccessful, and
if the revert change procedure is unsuccessful, the method further comprises triggering a repair script.

4. The method of claim 3, wherein when the repair script is triggered, the method further comprises:
receiving an indication of a hostname and error type;
determining a device type from the hostname;
determining a repair procedure based on the device type and the error type to resolve the error type and return the device to the first configuration; and
applying the repair procedure to the device in attempt to resolve the error type.

5. The method of claim 4, wherein determining the repair procedure comprises predicting a best repair procedure using a machine learning model.

6. The method of claim 4, wherein determining the repair procedure comprises determining one or more known fixes for the device type and the error type.

7. The method of claim 4, wherein the error type is any one of: device is down, VPN is down, and memory/processing is too high.

8. The method of claim 4, further comprising:
determining if the error type has been resolved,
wherein:
if the error type has been resolved, the method further comprises storing the repair procedure in association with the device type and error type in the database of known fixes, and sending a notification that the error type has been resolved, and
if the error type has not been resolved, sending a notification that the error type has not been resolved.

9. The method of claim 8, further comprising, when the error type has not been resolved, determining if the device is critical, and sending a first notification if the device is critical, and sending a second notification if the device is not critical.

10. The method of claim 1, further comprising:
confirming, before implementing the change procedure, that the device is reachable over the network; and
when the device is not reachable, indicating a change failure.

11. The method of claim 1, wherein if the validation testing indicates that the change to the device is successful, the method further comprises performing a post-configuration backup to store a second configuration of the device after applying the change.

12. A method of repairing a device on a network, comprising:
receiving an indication of a hostname and error type;
determining a device type from the hostname;
determining a repair procedure based on the device type and the error type to resolve the error type and return the device to the configuration prior to applying the change; and
applying the repair procedure to the device in attempt to resolve the error type.

13. The method of claim 12, wherein determining the repair procedure comprises predicting a best repair procedure using a machine learning model.

14. The method of claim 12, wherein determining the repair procedure comprises determining one or more known fixes for the device type and the error type.

15. The method of claim 12, wherein the error type is any one of: device is down, VPN is down, and memory/processing is too high.

16. The method of claim 12, further comprising:
determining if the error type has been resolved,
wherein:
if the error type has been resolved, the method further comprises storing the repair procedure in association with the device type and error type in the database of known fixes, and sending a notification that the error type has been resolved, and
if the error type has not been resolved, sending a notification that the error type has not been resolved.

17. The method of claim 16, further comprising, when the error type has not been resolved, determining if the device is critical, and sending a first notification if the device is critical, and sending a second notification if the device is not critical.

18. The method of claim 14, wherein receiving the indication of the device type and the error type is received from a monitoring system that monitors the device, or from a change system that attempted to apply a change to the device.

19. A system, comprising:
a processor; and
a non-transitory computer-readable memory storing computer-executable instructions thereon, which when executed by a processor, configure the system to perform the method of claim 1.

20. A non-transitory computer-readable memory storing computer-executable instructions thereon, which when executed by a processor, configure the processor to perform the method of claim 1.
